(19) United States
(12) Patent Application Publication
(10) Pub. No.: US 2022/0414429 A1
(43) Pub. Date: Dec. 29, 2022

(54) PHYSICS-INFORMED ATTENTION-BASED NEURAL NETWORK

(71) Applicant: OriGen, Brooklyn, NY (US)

(72) Inventors: Ruben Rodriguez Torrado, Hoboken, NJ (US); Pablo Ruiz Mataran, Granada (ES)

(21) Appl. No.: 17/743,112

(22) Filed: May 12, 2022

Related U.S. Application Data
(60) Provisional application No. 63/188,087, filed on May 13, 2021.

(51) Int. Cl. G06N 3/04; G06N 3/08

(52) U.S. Cl. CPC G06N 3/0445; G06N 3/08

(57) ABSTRACT

A physics-informed attention-based neural network (PIANN) system, wherein the PIANN system is a computer system configured to implement a PIANN, the computer system comprising at least one processor and memory storing computer instructions, wherein, when the at least one processor executes the computer instructions, the PIANN system is trained to learn a solution or model for a partial differential equation (PDE) respecting one or more physical constraints, and wherein the PIANN includes a physics-informed neural network (PINN) implementing a deep neural network and a transition zone detector. According to at least some implementations, the PIANN implements a recurrent neural network (RNN).

### TECHNICAL FIELD

This disclosure relates to methods and systems for deep learning and, in particular, relates to use of deep learning for solving complex problems having physical constraint(s), such as respecting physical law(s) or condition(s).

### BACKGROUND

The explosion of research in deep learning over the last 10 years or so has brought a resurgence to many areas of research. Starting with classification, to regression, natural language processing, reinforcement learning, and generative unsupervised and semi-supervised algorithms, there are many new developments to be looked into. Some of these new developments can be harnessed to bring new possibilities to other artificial intelligence (AI) approaches. However, deep learning techniques often require a huge amount of data (e.g., hundreds of thousands) during the training process and present several shortcomings when used for generating solutions that respect several constraints (e.g., fluid dynamic laws when attempting to reproduce movement of fluid, playability for video games simulating physical constraints).

Deep neural networks (DNNs) have achieved enormous success in recent years because they have significantly expanded the scope of possible tasks that they can perform, given sufficiently large datasets (Sejnowski T J The unreasonable effectiveness of deep learning in artificial intelligence. PNAS 117:30033-30038 (2020)). The range of applications is extraordinary, from natural language processing, image analysis and autonomous driving, to earthquake forecasting, playing videogames and, more recently, numerical differentiation. Neural networks can approximate the solution of differential equations (Regazzoni F, Dedé L, Quarteroni A (2019) Machine learning for fast and reliable solution of time-dependent differential equations. Journal of Computational Physics 397:108852; Samaniego E, et al. (2020) An energy approach to the solution of partial differential equations in computational mechanics via machine learning: Concepts, implementation and applications. Computer Methods in Applied Mechanics and Engineering 362:112790 (“Samaniego E, et al.”)), in particular high-dimensional partial differential equations (PDEs) (Han J, Jentzen A, E W (2018) Solving high-dimensional partial differential equations using deep learning. PNAS 115:8505-8510; Beck C, Hutzenthaler M, Jentzen A, Kuckuck B (2020) An overview on deep learning-based approximation methods for partial differential equations. arXiv preprint arXiv:2012.12348).

One of the most remarkable approaches for solving non-linear PDEs is physics-informed neural networks (PINNs) (Raissi M, Perdikaris P, Karniadakis G E (2019) Physics-informed neural networks: A deep learning framework for solving forward and inverse problems involving nonlinear partial differential equations. Journal of Computational Physics 378:686-707 (“Raissi et al”); Raissi M, Perdikaris P, Karniadakis G E (2017) Physics informed deep learning (part i): Data-driven solutions of nonlinear partial differential equations. arXiv preprint arXiv:1711.10561). PINNs are trained to solve supervised learning tasks constrained by PDEs, such as the 6 conservation laws in continuum theories of fluid and solid mechanics (Samaniego E, et al.; Raissi M, Yazdani A, Karniadakis G E (2020) Hidden fluid mechanics: Learning velocity and pressure fields from flow visualizations. Science 367:1026-1030; Brunton S L, Noack B R, Koumoutsakos P (2020) Machine learning for fluid mechanics. Annual Review of Fluid Mechanics 52:477-508; Kadeethum T, Jørgensen T M, Nick H M (2020) Physics-informed neural networks for solving nonlinear diffusivity and biot's equations. PloS one 15(5):e0232683 (Kadeethum et al.)). The idea behind PINNs is to train the network using automatic differentiation (AD) by calculating and minimizing the residual, usually constrained by initial and boundary conditions, and possibly observed data (Raissi et al.). PINNs have the potential to serve as on-demand, efficient simulators for physical processes described by differential equations (the forward problem) (Raissi et al.; Kadeethum et al.). If trained accurately, PINNs can work faster and more accurately than numerical simulators of complex real-world phenomena. PINNs may also be used to assimilate data and observations into numerical models, or be used in parameter identification (the inverse problem) (Raissi et al.) and uncertainty quantification (Mao Z, Jagtap A D, Karniadakis G E (2020) Physics-informed neural networks for high-speed flows. Computer Methods in Applied Mechanics and Engineering 360:112789 (“Mao Z, Jagtap et al.”); Jagtap A D, Kharazmi E, Karniadakis G E (2020) Conservative physics-informed neural networks on discrete domains for conservation laws: Applications to forward and inverse problems. Computer Methods in Applied Mechanics and Engineering 365:113028; Zhang D, Lu L, Guo L, Karniadakis G E (2019) Quantifying total uncertainty in physics informed neural networks for solving forward and inverse stochastic problems. Journal of Computational Physics 397:108850; Tipireddy R, Barajas-Solano D A, Tartakovsky A M (2020) Conditional karhunen-loeve expansion for uncertainty quantification and active learning in partial differential equation models. Journal of Computational Physics 418:109604).

PINNs have enabled significant improvements in modelling physical processes described by PDEs. PINNs are based on simple architectures, and learn the behavior of complex physical systems by optimizing the network parameters to minimize the residual of the underlying PDE. Current network architectures share some of the limitations of classical numerical discretization schemes when applied to non-linear differential equations in continuum mechanics. A paradigmatic example is the solution of hyperbolic PDEs. Hyperbolic conservation laws describe a plethora of physical systems in gas dynamics, acoustics, elastodynamics, optics, geophysics, and biomechanics (Dafermos C M (2000) Hyperbolic Conservation Laws in Continuum Physics, Berlin. (Springer Verlag)). Hyperbolic PDEs are challenging to solve numerically using classical discretization schemes, because they tend to form self-sharpening, highly-localized, nonlinear shock waves that require specific approximation strategies and fine meshes (Leveque R J (1992) Numerical Methods for Conservation Laws (2. ed.), Lectures in Mathematics: ETH Zurich. (Birkäuser)). On the other hand, the ability of current PINNs to learn PDEs with a dominant hyperbolic character relies on adding artificial dissipation (H. A. Tchelepi, O. Fuks, H A (2020) Limitations of physics informed machine learning for nonlinear two-phase transport in porous media. Journal of Machine Learning for Modeling and Computing 1(1) (“Tchelepi et al.”); Fraces C G, Papaioannou A, Tchelepi H (2020) Physics informed deep learning for transport in porous media. buckley leverett problem; Michoski C, Milosavljevic M, Oliver T, Hatch D R (2020) Solving differential equations using deep neural networks. Neurocomputing 399:193-212), or on using a priori knowledge to increase the number of training points along the shock trajectories (Mao Z, Jagtap et al.) or adaptive access functions (Jagtap, A. D., Kawaguchi, K. & Karniadakis, G. E. Adaptive activation functions accelerate convergence in deep and physics-informed neural networks. J. Comput. Phys. 404, 109136 (2020)).

In connection with oil reservoir modeling, for example, such as for modern oil and gas exploration, a placement of even a single well in a bad spot may result in a significant financial loss. A reservoir model (RM) is a computerized representation of a field drawing from various data sources, such as geological expert analyses, seismic measurements, well logs, etc., with added properties determining dynamic reservoir behavior. Its primary purpose is oftentimes to allow optimization and better prediction of the field future output using mathematical simulators. Given a set of input actions (well drilling), a simulator operates on an RM by solving large systems of nonlinear PDEs to predict future outcomes over long time horizons (up to tens of years).

As is described in Z. L. Jin, Y. Liu, L. J. Durlofsky, Deep-learning-based surrogate model for reservoir simulation with time-varying well controls, Journal of Petroleum Science and Engineering (2020) 107273 (“Jin et al.”), the governing equations for immiscible oil-water flow derive from mass conservation for each component combined with Darcy's law for each phase. The resulting equations, with capillary pressure effects neglected, are:

$$\frac{\partial ϕ {ρ}_{j} {S}_{j}}{\partial t} - ▽ . ( {λ}_{j} {ρ}_{j} k ▽ p ) + {\sum }_{w} {ρ}_{j} {q}_{j}^{w} = 0 \qquad Equation ( 1 )$$

where subscript j (for j=o, w oil and water) denotes fluid phase. The geological characterization is represented in Equation 1 through porosity ϕ and the permeability tensor k, while the interactions between rock and fluids are specified by the phase mobilities ratio of effective permeability to phase viscosity, λⱼ, where λⱼ=kᵣⱼ/μⱼ with kᵣⱼ the relative permeability and μⱼ the viscosity of phase j. Other variables are pressure p and phase saturation Sⱼ these are the primary solution variables), time t, and phase density ρⱼ. The q term denotes the phase source/sink term for well w. This oil-water model is completed by enforcing the saturation constraint Sₒ+S_{w}=1. The oil and water flow equations are discretized using a standard finite-volume formulation, and their solutions are computed for each grid block. In the disclosed proposal, a commercial reservoir simulator, Eclipse, Ø. Pettersen, Basics of reservoir simulation with the eclipse reservoir simulator, Lecture Notes. University of Bergen, Norway (2006) 114, is used for all flow simulations.

Let n_{b} denote the number of grid blocks in the model. The flow system is fully defined through the use of two primary variables, p and S_{w}, in each grid block, so the total number of variables in the system is 2×n_{b}. Then xₜ=[pₜ^{T},Sₜ^{T}] in [symbol] ²ⁿ^{^{b}} is defined to be the state vector for the flow variables at a specific time step t, where pₜ in [symbol] ⁿ^{^{b}} and Sₜ in [symbol] ⁿ^{^{b}} denote the pressure and saturation in every grid block at time step t. The set of nonlinear algebraic equations representing the discretized fully implicit system can be expressed as:

g(xₜ₊₁,xₜ,uₜ₊₁)=0 Equation (2)

Where g in [symbol] ²ⁿ^{^{b}} is the residual vector (set of nonlinear algebraic equations built with the left side of the equation 1) that is to be driven to zero, the subscript t indicates the current time level and t+1 the next time level, and uₜ₊₁ in [symbol] ⁿ^{^{w}} designates the well control variables, which can be any combination of time-varying bottom-hole pressures (BHPs) or well rates. Here, n_{w} denotes the number of wells in the system. Newton's method is typically used to solve the full-order discretized nonlinear system defined by Equation 2. This requires constructing the sparse Jacobian matrix of dimension 2n_{b}×2n_{b}, and then solving a linear system of dimension 2n_{b}, at each iteration for every time step.

Solution(s) of the linear system is often the most time-consuming part of a simulation. Therefore, RM simulators may require a considerable amount of computation (time) to produce predictions (minutes, hours, or days, depending on the RM size). This limits the use of any optimization technique in the oil and gas industry. Recently, several authors have proposed the use of deep learning to accelerate the RM simulator using the notable results obtained by the spectrum of deep learning architectures and techniques in different domains. Concretely, J. Navratil, A. King, J. Rios, G. Kollias, R. Torrado, A. Codas, Accelerating physics-based simulations using neural network proxies: An application in oil reservoir modeling, Frontiers in Big Data 2 (2019) 33 proposes the use of a seq-to-seq recurrent neural network for the prediction of well rates in black-oil model with three phases. This application reduces the simulation time around 4 order of magnitude. However, these models usually requires the availability of large amounts of labeled data around 130 k simulations. In many real reservoir applications, data acquisition is often prohibitively expensive, and the amount of labeled data is usually quite limited to a few dozens.

On other note, several authors such as Tchelepi et al. use domain knowledge to reduce the need for labeled training data, or even aim to train ML models without any labeled data relying only on constraints R. Stewart, S. Ermon, Label-free supervision of neural networks with physics and domain knowledge, in: Thirty-First AAAI Conference on Artificial Intelligence. These constraints are used to encode the specific structure and properties of the output that are known to hold because of domain knowledge, e.g., known physics laws such as conservation of momentum, mass, and energy. This new domain is known as physics informed neural network (PINN).

Physics informed neural network approaches have been explored recently in a variety of computational physics problems, whereby the focus is on enabling the neural network to learn the solutions of deterministic partial differential equations (PDEs). However, in the context of modern neural network architectures, the interest in this topic has been revived. PINN approaches are designed to obtain data-driven solutions of general nonlinear PDEs, and they may be a promising alternative to traditional numerical methods for solving PDEs, such as finite-difference and finite-volume methods. The core idea of PINN is that the developed neural network encodes the underlying physical law as prior information computing the gradients based on automatic differentiation (AD) (A. G. Baydin, B. A. Pearlmutter, A. A. Radul, J. M. Siskind, Automatic differentiation in machine learning: a survey, The Journal of Machine Learning Research 18 (2017) 5595-5637) which is available in the majority of open source library for deep learning (e.g., pytorch, tensorflow), and then uses this information during the training process minimizing the residual described in Equation 1.

Recently, Tchelepi et al. shows that the neural network approach struggles and even fails for modeling the nonlinear hyperbolic PDE that governs two-phase transport in porous media. This experiments demonstrate that the neural network completely misses the correct location of the saturation front due to we have a discontinuity in the derivative, which leads to high values of the loss and large prediction errors.

Deep learning can be used to simulate complex dynamic systems while respecting existing laws of physics as described by general nonlinear partial differential equations. Such approaches have shown impressive results using data from expensive simulators. However, these systems tend to have low accuracy, and to be prone to overfitting, when limited amounts of information are available (e.g. a few hundred data points), Jin et al. Additionally, it can be difficult to represent simple physics concepts in a deep learning architecture to induce the models to respect physical laws, for example, the movement of the water saturation front

### SUMMARY

According to one aspect of the disclosure, there is provided a physics-informed attention-based neural network (PIANN) system, wherein the PIANN system is a computer system configured to implement a PIANN, the computer system comprising at least one processor and memory storing computer instructions, wherein, when the at least one processor executes the computer instructions, the PIANN system is trained to learn a solution or model for a partial differential equation (PDE) respecting one or more physical constraints, wherein the PIANN includes a physics-informed neural network (PINN) implementing a deep neural network and a transition zone detector, and wherein the PIANN implements a recurrent neural network (RNN).

According to various embodiments, the PIANN system may further include any one of the following features or any technically-feasible combination of some or all of the following features:
the PIANN includes an encoder and a decoder;
the encoder is used to map an encoder input to an encoder output in an embedding space, and wherein the decoder is used to map a decoder input in the embedding space to a decoder output;
the encoder input size and decoder input size are equal;
a linear transition layer is introduced in the embedding space between the encoder and the decoder;
the PIANN includes a plurality of RNN units;
the plurality of RNN units include at least one gated recurrent unit (GRU) and/or at least one long short-term memory (LSTM);
the one or more RNN units include a plurality of GRUs;
the one or more RNN units include a first plurality of GRUs and a second plurality of GRUs, and wherein the first plurality of GRUs are used as a part of an encoder of the PIANN and the second plurality of GRUs are used as a part of a decoder of the PIANN;
the transition zone detector includes an attention mechanism is implemented as an attention layer introduced between the first plurality of GRUs and the second plurality of GRUs;
the attention layer is used to calculate a context vector based on encoder hidden states corresponding to the first plurality of GRUs;
the context vector is calculated based on attention weights that are determined based on the encoder hidden states corresponding to the first plurality of GRUs;
the context vector is used as input into at least one of the second plurality of GRUs;
the PDE is a non-linear PDE;
the PDE is a hyperbolic PDE;
the PIANN includes an automatic differentiator for producing a differentiation output, and wherein the differentiation output is used for training the PIANN in order to update one or more parameters or weights of the PIANN;
the one or more parameters or weights of the PIANN include one or more transition zone detector weights or parameters of the transition zone detector;
the transition zone detector is an attention mechanism and the transition zone detector weights or parameters are attention weights of the attention mechanism; and/or
the PIANN is structured as a seq-to-seq RNN.

According to yet another aspect of the disclosure, there is provided a physics-informed attention-based neural network (PIANN) system, wherein the PIANN system is a computer system configured to implement a PIANN, the computer system comprising at least one processor and memory storing computer instructions, wherein, when the at least one processor executes the computer instructions, the PIANN is used to generate a surrogate model for use in generating a simulation output, and wherein the PIANN includes a physics-informed neural network (PINN) with an attention mechanism introduced into an embedding space of the PINN between an encoder and a decoder of the PINN.

According to various embodiments, the PIANN system may further include any one of the following features or any technically-feasible combination of some or all of the following features:
the attention mechanism is a hard attention mechanism;
the attention mechanism is a soft attention mechanism;
the PIANN includes an encoder-decoder recurrent neural network (RNN) configuration having a plurality of RNN units;
the plurality of RNN units are used to generate an encoder output in the embedding space and/or to generate a decoder input in the embedding space;
the PIANN includes automatic differentiator for producing a differentiation output, and wherein the differentiation output is used by a physics-informed learning unit for physics-informed learning or training of the PINN;
the PIANN includes a physics-informed learning unit that is uses a physical loss function;
the physical loss function is formulated based on a Buckley-Leverett (BL) equation; and/or
the surrogate model is a reservoir model; and/or the physics-informed learning unit enforces one or more initial conditions and one or more boundary conditions representing or selected in accordance with one or more physical constraints.

According to yet another aspect of the disclosure, there is provided a deep neural network (DNN) system, wherein the DNN system is a computer system configured to implement a DNN having an encoder and a decoder coupled together in an embedding space through an attention layer implementing an attention mechanism, the computer system comprising at least one processor and memory storing computer instructions. When the at least one processor executes the computer instructions, the DNN architecture is used to generate a DNN output that respects one or more predetermined physical constraints.

According to various embodiments, the PIANN system may further include any one of the following features: the attention layer is coupled to a plurality of recurrent neural network (RNN) units of the encoder and coupled to a plurality of RNN units of the decoder; and/or one or more weights or parameters of the encoder, the decoder, and/or the attention layer are trained using a physics-informed learning unit that is uses a physical loss function and that respects the one or more predetermined physical constraints.

### BRIEF DESCRIPTION OF THE DRAWINGS

Preferred exemplary embodiments will hereinafter be described in conjunction with the appended drawings, wherein like designations denote like elements, and wherein:

FIG. 1 is a diagrammatic illustration of a physics-informed attention-based neural network (PIANN), according to at least one embodiment;

FIG. 2 is a diagrammatic illustration of the PIANN of FIG. 1, illustrating use of recurrent memory through a plurality or recurrent neural network (RNN) units in combination with a transition zone detector that is illustrated as being implemented as an attention mechanism or attention layer according to the depicted embodiment;

FIG. 3 is a diagrammatic illustration of exemplary detail for implement the PIANN of FIGS. 1 and 2 according to one embodiment, illustrating the plurality of RNN units as gated recurrent units (GRUs) and calculation of the prediction output using the attention layer;

FIG. 4 is a diagrammatic illustration of an operating environment for the PIANN system of FIGS. 1-3, according to one embodiment;

FIG. 5 is an illustration of the PIANN of FIGS. 1-3 for generating a surrogate model having an input and output specified as 6 million (6M) in size, according to one embodiment and exemplary implementation;

FIG. 6 shows the error propagation for different timesteps and, in particular, mean square error (MSE) of transition network with respect to different timesteps according to one embodiment and exemplary implementation; and

FIG. 7 shows correlation error between the hidden spaces (after encoding) for different timesteps of the transition PINN, according to one embodiment and exemplary implementation.

### DETAILED DESCRIPTION

The system and method described herein enables a deep learning architecture to implement a physics-informed attention-based neural network, which extends a physics-informed neural network (PINN) by introducing a transition zone detector and/or through using, according to at least some embodiments, an encoder-decoder recurrent neural network (RNN) configuration. The transition zone detector is used to identify the correlation with input data to identify automatically the shock or non-linearity of the differential equation and make a better correlation between the input and the output. A first example of a transition zone detector is an attention mechanism and a second example of a transition zone detector is an adaptive activation function. This proposed network, deemed a physics-informed attention-based neural network or “PIANN”, adapts the behavior of its deep neural network to non-linear features of the solution to a partial differential equation (PDE), and breaks the current limitations of PINNs, such as through use of the attention mechanism or other transition zone detector; it should be appreciated that the PIANN is not limited to use of an attention mechanism and may use other transition zone detector(s), such as adaptive activation function(s) even though the PIANN uses the term “attention”. As is discussed in more detail below, according to at least one exemplary implementation of the PIANN, it has been found that the PIANNs effectively capture the shock front in a hyperbolic model problem, and are capable of providing high-quality solutions inside the convex hull of the training set.

One of the main challenges in developing a PINN model is being able to train and achieve sufficient accuracy with a small amount of data, and this problem exists in many fields that involve PDEs, such as reservoir modeling as illustrated in the present example. In particular, certain fields or applications may involve simulating complex systems that are modelled by numerous variables having non-linear relationships. There is oftentimes a scenario where only a small number of simulations or data used for training may be obtained and, thus, AI-based approaches to developing surrogate models, such as through use of neural networks, suffer. According to at least some embodiments, the PIANN 12 overcomes such limitations by implementing a recurrent memory feature (as a result of the encoder-decoder RNN configuration) and through use of an attention mechanism. As will be discussed more below as a part of Example 1, for implementing the PIANN 12 for reservoir modeling, a main goal may be stated as, given a minimal number of reservoir simulations (e.g., less than a hundred or some other predetermined number), to develop a surrogate model that can predict the full simulation maps (e.g., pressure and saturation). The surrogate model is represented by the PIANN 12 that is constructed and trained. As stated above, an objective is to integrate physical concepts into deep learning to enable deep learning to produce solutions that respect physical laws, conditions, or other constraints. For that reason, the introduction of differential equations, new attention mechanisms, and mathematical formulation in deep neural networks have been introduced to better guarantee that solutions generated by the deep neural network respect physical laws.

As mentioned above, deep learning can be used to simulate complex dynamic systems while respecting existing laws of physics as described by general nonlinear PDEs. Conventional systems tend to have low accuracy and to be prone to overfitting, especially when limited amounts of information are available (e.g., a few hundred data points). Additionally, it can be difficult to represent simple physics concepts in a deep learning architecture to induce the models to respect physical laws, for example, the movement of the water saturation front. According to exemplary embodiments, and as illustrated below, the PIANN described herein may be used to address such problems.

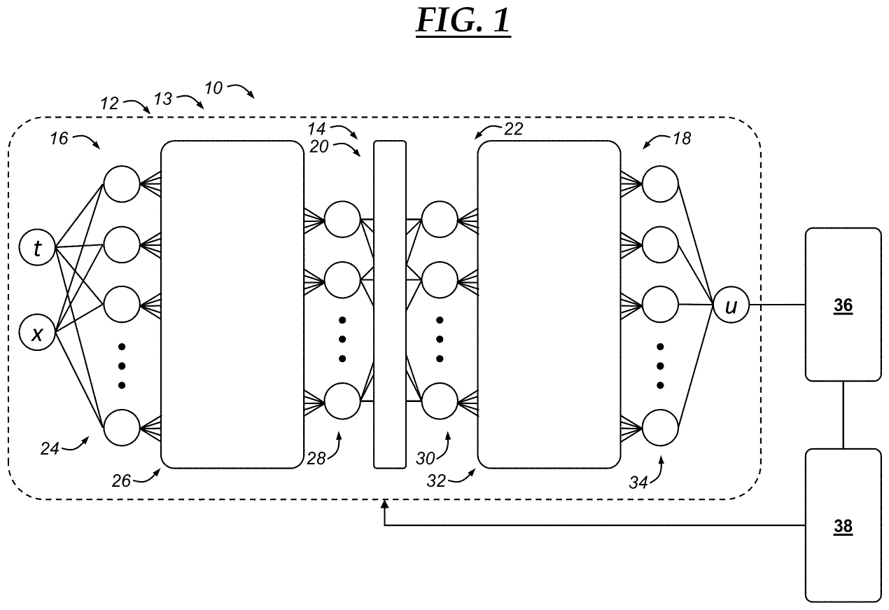

With reference now to FIG. 1, there is shown a physics-informed attention-based neural network (PIANN) system 10, which includes a physics-informed attention-based neural network (PIANN) 12 that is configured to include a transition zone detector 14, which is a part of a transition zone detector layer. The PIANN 12 uses a physics-informed neural network (PINN) architecture 13 and is considered as including a PINN 13.

The PIANN 12 includes an encoder 16, a decoder 18, and a linear transition layer 20 connected within an embedding space 22 between the encoder 16 and the decoder 18. The encoder 16 is illustrated as taking two inputs, time t and input data x; however, this may be modified depending on the particular application in which the PIANN 12 is used. The encoder 16 is shown as including an input layer 24, one or more hidden layers 26, and an embedding layer 28. The linear transition layer 20 is disposed within the embedding space 22 and evolves the latent variable from one timestep to the next, given the controls. The linear transition layer 20 thus spans between the embedding layer 28 of the encoder 16 and an embedding layer 30 of the decoder 18 within the embedding space 22. The decoder 18 is shown as including the embedding layer 30, one or more hidden layers 32, and an output layer 34. The encoder 16 is used to map an encoder input (indicated at the input layer 24) to an encoder output (indicated at the embedding layer 28) in the embedding space 22, and the decoder 18 is used to map a decoder input (indicated at the embedding layer 30) in the embedding space 22 to a decoder output (indicated at the output layer 34). The output layer 34 of the decoder 18, which is represented by u, is then used by an automatic differentiator 36 that performs an automatic differentiation (AD) technique to produce a differentiated output, which may be a residual of a partial differential equation (PDE), and this output is then used by a physics-informed learning unit 38 to carry out physics-informed learning for the PIANN 12.

According to at least some embodiments, the PIANN system 10 is a computer system configured to implement the PIANN 12, where the computer system includes at least one processor and memory storing computer instructions. According to such embodiments, when the computer instructions are executed by the at least one processor, the PIANN system 10 is trained to learn a solution or model for a PDE respecting one or more predetermined physical constraints, such as one or more physical laws, conditions, etc. The PIANN 12 includes a PINN implementing a deep neural network (DNN) and a transition zone detector 14, and the PIANN implements a recurrent neural network (RNN). As used herein, a DNN means a neural network having at least one hidden layer.

According to some embodiments, the PIANN system 10 is a computer system configured to implement the PIANN 12, the computer system comprising at least one processor and memory storing computer instructions, wherein, when the at least one processor executes the computer instructions, the PIANN 12 is used to generate a surrogate model for use in generating a simulation output, and wherein the PIANN 12 includes a physics-informed neural network (PINN) with an attention mechanism introduced into an embedding space of the PINN 13 between the encoder 16 and the decoder 18 of the PINN 13.

According to some embodiments, the PIANN system 10 embodies a deep neural network (DNN) system, wherein the DNN system is a computer system configured to implement a DNN (e.g., the PINN of the PIANN 12) having the encoder 16 and the decoder 18 coupled together in the embedding space 22 through the transition zone detector 14 implementing an attention mechanism, the computer system comprising at least one processor and memory storing computer instructions. According to such embodiments, when the at least one processor executes the computer instructions, the DNN architecture is used to generate a DNN output that respects one or more predetermined physical constraints.

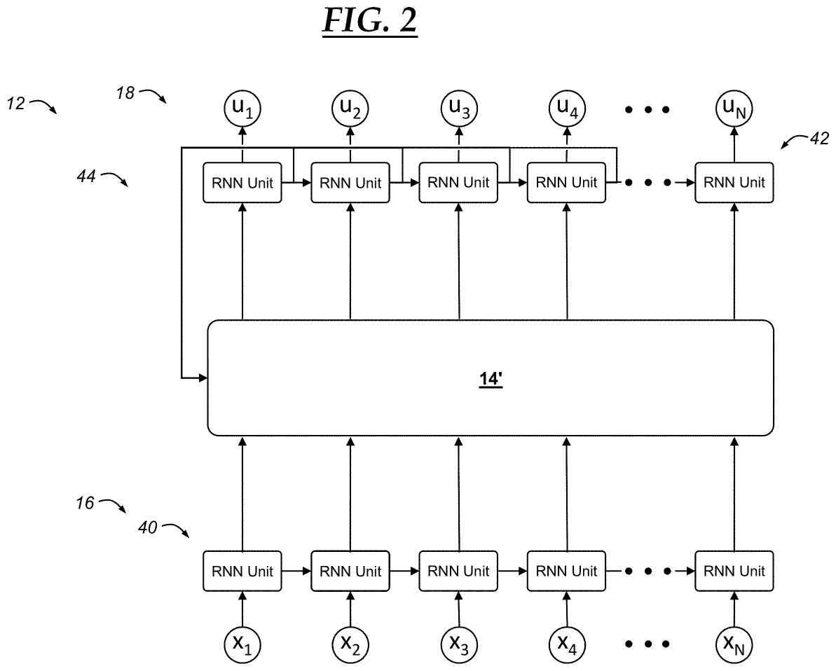

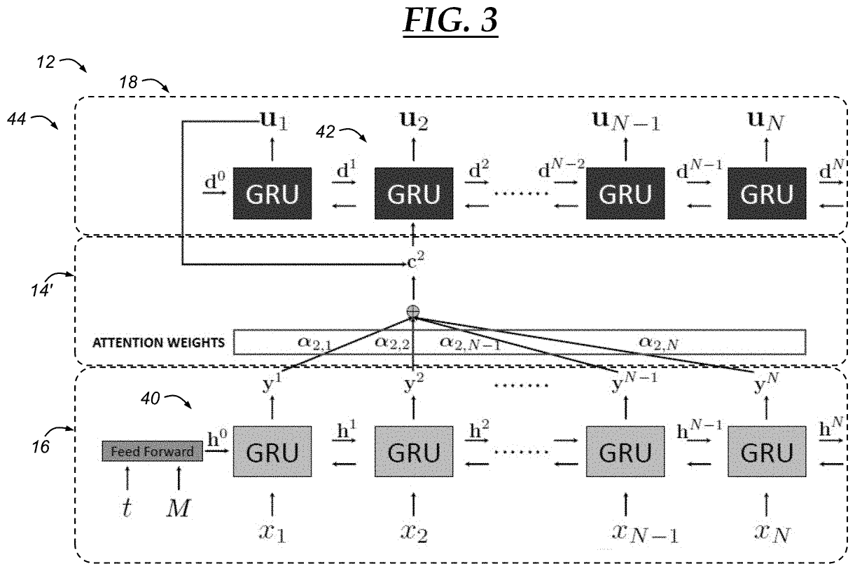

With reference to FIGS. 2-3, and with continued reference to FIG. 1, there is shown a representation of the PIANN 12, including the encoder 16, the decoder 18, and the transition zone detector that is implemented in the present embodiment of FIGS. 2-3 as an attention layer 14′ that is disposed between the encoder 16 and the decoder 18. In particular, FIG. 2 provides a representation of the attention layer 14′ generally whereas FIG. 3 depicts a representation of the attention layer 14′ as used for determining decoder output for u₂.

According to one embodiment, the PIANN 12 includes a plurality of recurrent neural network (RNN) units, such as gated recurrent units (GRUs) or long short-term memory (LSTM). In the depicted embodiment, the plurality of RNN units are illustrated as being GRUs and formed in an encoder-decoder RNN configuration in which the encoder 16 includes a plurality of GRUs 40 and the decoder 18 includes a plurality of GRUs 42. Use of the encoder-decoder GRU configuration, such as is illustrated in FIGS. 2 and 3, may be used with the attention layer 14′ (or other transition zone detector) for memory recurrent, attention-based learning.

The attention layer 14′ includes determining a context vector (c² in the example of FIG. 3) based on attention weights for the variable to be predicted (variable u₂ in the example of FIG. 3) and encoder hidden states (y₁, y₂, . . . y_{N-1}, y_{N} in the example of FIG. 3). The context vector and the output of the decoder from the previous timestep (referred to as “previous decoder output”) (represented as u₁ in the example of FIG. 3) are passed into one of the GRUs 42 of the decoder 18 (GRU 42-2 in the example of FIG. 3). This GRU of the decoder 18 (GRU 42-2 in the example of FIG. 3) then determines the predicted variable (u₂ in the example of FIG. 3) using the context vector, the previous decoder output, and the previous decoder's hidden state (d₁ in the example of FIG. 3). According to at least some embodiment, the combination of the RNN units (and, particularly, the encoder-decoder RNN configuration as illustrated by the GRUs 40 and 42 in the depicted embodiment) and the attention mechanism (as represented by the attention layer 14′ in the depicted embodiment) enables determination of the most relevant information to adapt the behavior of the neural network (RNN units) so that it generates an approximate or prediction without drawbacks noted above, including without needing residual regularization or a priori knowledge (attention mechanism).

With reference back to FIG. 1, the predicted variable (u₂ in the example of FIG. 3) is passed into the automatic differentiator 36, which then uses AD to generate the differentiated output and, according to at least some embodiments, the differentiated output of the automatic differentiator 36 includes one or more residuals of a partial differential equation (PDE), such as one or more first and/or second derivative terms. In some embodiments, the automatic differentiator 36 may use an open source library, such as pytorch or tensorflow. In other embodiments, numerical calculation may be used for simplification, as taught in Jin et al. The differentiated output, which may be determined by the automatic differentiator 36 or numerical calculation. The automatic differentiator 36 enables loss functions to be constrained or driven by governing physical properties, conditions, or laws. The physical loss function may be defined in accordance with the differentiated output, boundary conditions, and initial conditions; the physical model, including the boundary conditions and initial conditions, may be specified by an operator, such as through use of a client application executing on a client computing machine.

The physics-informed learning unit 38 is used to perform learning and for training the encoder 16 and the decoder 18 using a physical loss function. In at least some embodiments, the encoder 16 and the decoder 18 are trained using a physical loss function at the same time and with physical attention, which means that an attention mechanism is introduced and used for training. The physics-informed learning unit 38 may use or implement any number of learning techniques, including various gradient descent or loss minimization techniques; in one embodiment the physics-informed learning unit 38 uses or implements the ADAM optimizer with a specified learning rate, such as 10-4. The physics-informed learning unit 38 is used to update parameters of the PIANN 12, including those of the encoder 16 and decoder 18.

According to one embodiment, a deep learning architecture 44 is provided, which may be referred to generally as a generative physical network 44 and, at least according to some embodiments, aims to solve one or more challenges presented above. The disclosed deep learning architecture 44 is implemented in the present embodiment as the PIANN 12 and is considered to be based on three components: (1) a neural physics network (corresponding to the encoder 16 of FIG. 1) that constructs an internal representation of the physical properties in an embedding space (corresponding to the embedding space 22 of FIG. 1); 2) a physical memory solver (corresponding to the linear transition layer 20 of FIG. 1) that uses this representation to predict the future timesteps of the dynamic system; and 3) a transposed neural physical network (corresponding to the decoder 18) that returns the prediction representation to the original physical space. As discussed in more detail below, this workflow may be used for solving a variety of differential equations, such as those that govern the movement of the flow in porous media (reservoir simulation) as discussed in the exemplary implementation for reservoir modeling, discussed below. Moreover, according to at least some embodiments, the transition zone detector 14 (e.g., the attention mechanism 14′ or adaptive activation function(s)) is based on physical information that computes non-linearity, such as the water saturation front.

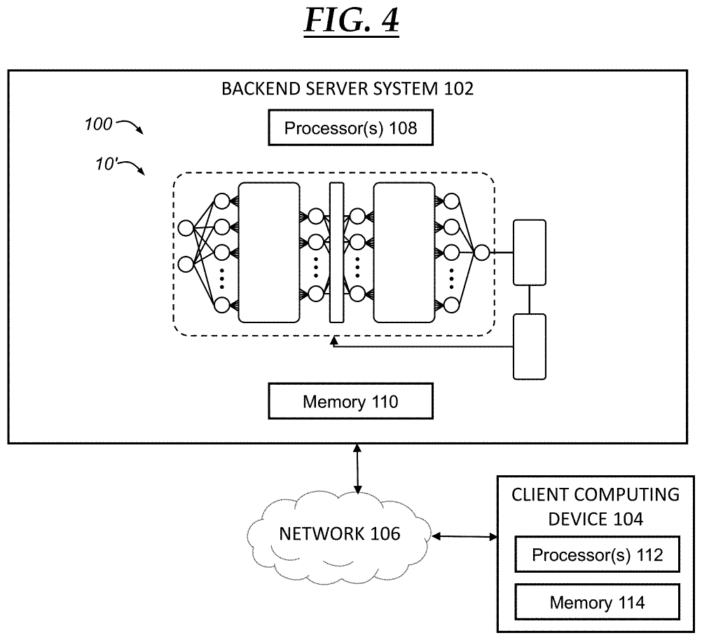

With reference to FIG. 4, there is shown an operating environment 100 for a PIANN system, which may be a computer-implemented PIANN system 10′ that implements the PIANN system 10. The operating environment 100 includes a backend server system 102, a client computing device 104, and a network 106 connecting the client computing device 104 to the backend server system 102. The backend server system 102 is shown as including processor(s) 108 and memory 110 and the client computing device 104 is shown as including processor(s) 112 and memory 114. The processor(s) 108 and memory 110 may be included in one or more computing devices of the backend server system 102. The backend server system 102 may include one or more computing devices and the client computing device is a computing device that is operated by an operator for using a computer application that is supported by the backend server system 102. A computing device is an electronic device having at least one processor and memory accessible by the processor, such as a personal computer, a server instance, a smartphone, a tablet. The backend server system 102 may include any suitable number of computing devices, and may include a variety of devices that may be co-located or remotely located from one another, such as when a cloud-based platform (e.g., Amazon Web Services™ Google Cloud™) is used for implementing portions of the backend server system 102. It should be appreciated that the embodiment of FIG. 4 is but one example of an operating environment that may be used for the PIANN system, and that the number, arrangement, and configuration of the components of the operating system may vary and/or depend on the application in which the PIANN system is used.

The backend server system 102 may be used for training the PIANN 12, including carrying out the physics-informed attention-based learning described herein. The training may use training data stored at a database of the backend server system 102. In some embodiments, the training data may be obtained from a third party computer system, such as through accessing open source data application programming interfaces (APIs) over the internet, for example. In other embodiments, the training data may be generated using one or more computer simulations and this generated training data may be then provided to the backend server system 102 for training the PIANN 12. In some embodiments, an operator may assist with executing the simulations used to generate data (used for training) and may use the client computing device 104 for doing so; in such an embodiment, this generated data may be sent to the backend server system 102 and stored as training data (it should be appreciated that the data received from the client computing device may be modified or processed so as to generate the training data, at least in some embodiments).

The client computing device 104 may be any of a variety of computing devices, such as a personal computer or desktop, a handheld mobile device (e.g., smartphone), laptop, etc. The client computing device 104 may use the network 106, which may be a cellular carrier network (in which case the client computing device 104 may include a cellular chipset for communicating with other components of the operating system 100), for communicating with the backend system 102. The client computing device 104 may also include short-range wireless communication (SRWC) circuitry enabling SRWC technologies (e.g., Wi-Fi™ Bluetooth) to be used to send and receive data. The client computing device 104 may use the SRWC circuitry to communicate with a wireless access point that is connected to the network 106, such as via a network access device (NAD) (e.g., a modem).

The network 106 represents a computer network that is operatively connected to the backend server system 102 and the client computing device 104, and may be implemented as a variety of different networking and computer componentry. For example, the network 106 could be a large interconnected data network such as the Internet and/or may include one or more local area networks (LANs) or could be implemented using one or more controller area networks (CANs). Of course, other network techniques and hardware may be used as these are just examples.

Any one or more of the processors discussed herein may be implemented as any suitable electronic hardware that is capable of processing computer instructions and may be selected based on the application in which it is to be used. Examples of types of electronic processors that may be used include central processing units (CPUs), graphics processing units (GPUs), field-programmable gate arrays (FPGAs), application specific integrated circuits (ASICs), microprocessors, microcontrollers, etc. Any one or more of the memory discussed herein may be non-transitory, computer-readable memory and may be implemented as any suitable type of memory that is capable of storing data or information in a non-volatile manner and in an electronic form so that the stored data or information is consumable by the electronic processor. The memory may be any a variety of different electronic memory types and may be selected based on the application in which it is to be used. Examples of types of memory that may be used include including magnetic or optical disc drives, ROM (read-only memory), solid-state drives (SSDs) (including other solid-state storage such as solid-state hybrid drives (SSHDs)), other types of flash memory, hard disk drives (HDDs), non-volatile random access memory (NVRAM), etc. It should be appreciated that the computers or computing devices may include other memory, such as volatile RAM that is used by the electronic processor, and/or may include multiple electronic processors.

Exemplary PIANN Architecture

Although it has been demonstrated that neural networks are universal function approximators, the proper choice of architecture generally aids learning and certain challenging problems (e.g. solving non-linear PDEs) may require more specific architectures to capture all their properties (see for instance Extreme Learning Machine, Dwivedi, V. & Srinivasan, B. Physics informed extreme learning machine (pielm)—a rapid method for the numerical solution of partial differential equations. Neurocomputing 391, 96-118. https://doi.org/10.1016/j.neucom.2019.12.099 (2020)). For that reason, the disclosed PIANN architecture is provided and may be adapted for solving non-linear PDEs with discontinuities under two assumptions: first, to automatically detect discontinuities, an architecture is needed that can exploit the correlations between the values of the solution for all spatial locations x₁, . . . , x_{N}; and, second, the architecture has to be flexible enough to capture different behaviors of the solution at different regions of the domain. To this end, at least according to some embodiments, the disclosed architecture has been developed that uses the encoder-decoder GRUs (such as that described above as the encoder-decoder RNN configuration), which may be used for predicting the solution at all locations at once, and the attention mechanism.

The disclosed approach, at least according to some embodiments, presents several advantages compared to traditional simulators: (i) Instead of using just neighboring cells' information to calculate u as in numerical methods, the disclosed architecture uses the complete encoded sequence input of the grid to obtain uᵢ allowing non-local relationships to be captured that numerical methods would struggle to identify. (ii) The computer time for the forward pass of neural networks models is linear with respect to the number of cells in the grid. In other words, the disclosed approach is a faster alternative with respect to traditional numerical methods of solving PDEs such as finite difference.

According to one embodiment, the PIANN 12 is used for generating a solution for a dynamic system, where the PIANN 12 has an architecture with (1) a neural physics network (corresponding to the encoder 16) that constructs an internal representation of the physical properties in an embedding space; (2) a physical memory solver uses the internal representation to predict the future time steps of the dynamic system (corresponding to the linear transition layer 20); (3) a transposed neural physical network (corresponding to the decoder 18) that returns the prediction representation to the original physical space; and (4) a transition zone detector, such as an attention mechanism, that is based on physical information that computes non-linearity, such as the water saturation front, for example.

FIG. 3 shows an outline of the proposed PIANN architecture according to one embodiment and is described generally above. With reference to FIG. 3, the input pair (t, M) is fed into a single fully connected layer (corresponding to the input layer 24 of the encoder 16 in FIG. 1). Thus, we obtain h⁰ the initial hidden state of a sequence of N GRU blocks (corresponding to GRUs 40 of the encoder 16). Each of the GRU blocks corresponds to a spatial coordinate xᵢ which is combined with the previous hidden state hⁱ⁻¹ inside the block. This generates a set of vectors y¹, . . . , y^{N} which can be understood as a representation of the input in a latent space, corresponding to the embedding layer 28 of FIG. 1. The definitive solution (the subindex θ is omitted for simplicity) is reached after a new sequence of GRU blocks 42 of the decoder 18 whose initial hidden state d⁰ is initialized as h^{N} to preserve the memory of the s stem.

In addition to the hidden state d¹, the i-th block gᵢ is fed with a concatenation of the solution at the previous location and a context vector, that is

uᵢ=gᵢ([uᵢ₋₁,cⁱ],dⁱ⁻¹)

According to at least some embodiments, the manner in which the context vector is obtained is an important aspect of the disclosed architecture, since it may be used to provide the PENN with enough flexibility to fit to the different behaviors of the solution depending on the region of the domain. A transition zone detector, which may be embodiment as an adaptive activation function or an attention mechanism such as that corresponding to the attention layer 14′ described above, is introduced between both GRU block sequences; that is, in FIG. 1, between the GRUs 40 of the encoder 16 and the GRUs 42 of the decoder 18. According to one embodiment, the transition zone detector 14 (or attention mechanism or layer 14′) is a single fully connected layer, a, that learns the relationship between each component of y^{j} and the hidden states of the GRU sequence (or for the GRUs 42),

ε_{i,j}=a(dⁱ⁻¹,y^{j})

Then, the rows of matrix E are normalized using a softmax function as

$${α}_{i , j} = \frac{exp ( {ε}_{i , j} )}{{\sum }_{j = 1}^{N} exp ( {ε}_{i , j} )}$$

and the context vectors are calculated as

$${c}^{i} = {\sum }_{j = 1}^{N} {α}_{i , j} {y}^{j} , i = 1 , … , N$$

The coefficients α_{i,j} can be understood as the degree of influence of the component y^{j} in the output uᵢ. This is one of the main innovations of our work to solve hyperbolic equations with discontinuities. The transition zone detector 14 automatically determines the most relevant encoded information of the full sequence of the input data to predict the uᵢ. In other words, transition zone detector 14 is a new method that allows one to determine the location of the shock automatically and provide more accurate behavior of the PIANN model around this location. This new methodology breaks the limitations explored by other authors (Mao Z, Jagtap et al.; Tchelepi et al.; Fraces et al.) since is able to capture the discontinuity without specific prior information or the regularization term of the residual.

According to at least some embodiments, the PIANN 12 may be use attention mechanisms to solve PDEs. Furthermore, according to some embodiments and implementations, the PIANN 12, including use of the transition zone detector 14, is particularly effective in addressing challenging nonlinear features of hyperbolic PDEs with discontinuous solution(s).

Exemplary Implementation of PIANN for Reservoir Modeling

The discussion below refers to an exemplary implementation of the PIANN 12 for purposes of reservoir modeling and, in particular, for generating a surrogate model for a reservoir, such as for purposes of oil and gas exploration. It should be appreciated that this discussion presents an exemplary implementation of the PIANN 12 and that the technical features and details discussed below may be applied to the PIANN 12, but do not necessarily limit the PIANN 12. Moreover, the discussion below relates to generating a PIANN (such as the PIANN 12) for reservoir modeling using a PIANN system having certain specified components, such as certain encoders, optimizers, etc. It should further be appreciated that, according to other implementations and/or embodiments, the PIANN and/or PIANN system may be adapted to use other components.

The input data of the neural physics network, or input for the input layer 24 of the encoder 16, are maps of petrophysical properties such as porosity, permeability, transmissibility, fluid properties (such as viscosity or fluid volume factor), fluid-rock properties (such as relative permeability maps) and the maps of pressure and saturation for the target timestep. All properties may be normalized and the initial conditions may be used in order to make a time normalization.

A Resnet-3D (K. He, X. Zhang, S. Ren, J. Sun, Deep residual learning for image recognition, in: Proceedings of the IEEE conference on computer vision and pattern recognition, pp. 770-778) as a deep neural architecture may be used for the encoder 16. The final layer (or embedding layer 28) of the encoder 16 is a linear layer with 2048 channels; in the present example, the initial dimension of the problem may be 6 million (6 M) cells (input layer 24 may be specified as 6M cells), and the encoder 16 here thus reduces this to 2,048 in the hidden layer(s) 26. Different Resnet architectures have been tested such as Resnet-50, Resnet-60, Resnet-101, and Resnet-134, and a variety of architectures, including any of these Resent architectures, may be used for the encoder 16 and may be selected based on the application in which it is used. For example, in order to select an architecture criterium such as to fit the deep neural network in commercial graphics processing units (GPUs) and reconstruction error have been used for metric. The Resnet with the best performance for the exemplary implementation is Resnet-50-3D.

Use of such an encoder architecture may present several limitations: 1) Maps of saturations and pressure have a small number of modifications between timesteps and hence maps of pressure and saturations oftentimes have large amounts of zeros; in other words, the input data contains massive sparsely populated matrices, which are difficult for deep convolutional neural networks (CNNs) to learn from due to the kernel of CNN having multiple multiplication by zero and bias term has a high domain effect. 2) CNNs excel at capturing spatial correlation within a neighborhood; however, physical problems may require a network to capture non-spatial correlations between cells that are far away, for example, correlations between injectors and producers; and 3) small differences in the results maps of saturation or pressure with respect to the ground truth may result in physical laws that are not respected; for example, small modifications in water saturation could cause an unbalance in material balance, physical law that governs the flow porous media simulation. For these above shortcomings, the attention mechanism, which may be referred to as a physical attention mechanism, is provided as described herein.

However, a main difference is the input data. Instead of using directly the map of saturation or pressure, the residual of the differential equation from the previous time step is used. A goal is to solve one of the big challenge of physics informed neural network (PINN) for the simulation of transport equation in porous media, tracking the cells that are relevant for physical concepts such as movement of the flow (e.g., the water front). The PIANN 12, according to at least some embodiments, adapts a self-attention mechanism or transition zone detector to work on physical problems.

To simplify the problem, a hard attention mechanism, such as that proposed by D. S. Touretzky, M. C. Mozer, M. E. Hasselmo, Advances in Neural Information Pro-cessing Systems 8: Proceedings of the 1995 Conference, volume 8, Mit Press, 1996, where we create a dynamic mask to identify the relevant part of the image [0,1] for each timestep, may be used as the transition zone detector 14 and is considered an example of an attention mechanism. A hard attention mechanism is an attention mechanism that makes a mask with just 0 or 1; in other words, it multiples by zero all parts of the input data which are consider not relevant. According to some embodiments, this may be considered akin to making a crop of an image. In another embodiment, a soft attention mechanism, such as that proposed by W. Li, X. Zhu, S. Gong, Harmonious attention network for person re-identification, in: Proceedings of the IEEE conference on computer vision and pattern recognition, pp. 2285-2294, may be used as the transition zone detector 14 and is considered an example of an attention mechanism. A soft attention mechanism is an attention mechanism that provides a probability for each pixel or portion of input; in other words, it determines the probability/relevance of the input data to make the prediction of the output.

Continuing in the workflow, an objective of the decoder 18 is to make the reconstruction from the latent space generated by the encoder for the unknown variables (maps of pressure and saturation) back to the original space and so a PINN may be used. One may compute the residuals, which correspond to the left-hand side of the PDEs such as in Equation 1, in the loss function of the neural networks. To construct the PDE residuals in the loss function, several first and/or second derivative terms of up and pp with respect to time t and space coordinates x are used, at least in some embodiments, and these may be computed based on automatic differentiation (AD), such as that set forth in Sun, L., Gao, H., Pan, S. & Wang, J.-X. Surrogate modeling for fluid flows based on physics-constrained deep learning without simulation data. Comput. Methods Appl. Mech. Eng. 361, 112732 (2020) and using the automatic differentiator 36, or through numerical calculation (see Jin et al.) using maps of pressure and saturation and petrophysical variables, L. S. K. Fung, A. Hiebert, L. X. Nghiem, et al., Reservoir simulation with a control-volume finite element method, SPE Reservoir Engineering 7 (1992) 349-357.

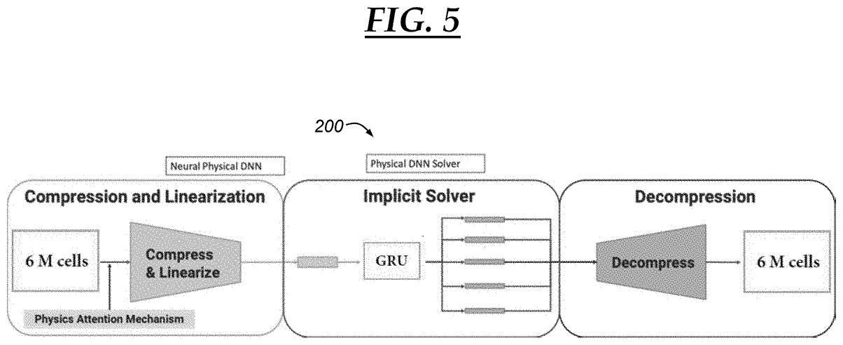

The encoder 16 and the decoder 18 may be trained at the same time with physical attention and physical loss function, as shown in FIG. 5. FIG. 5 illustrates that, according to embodiments, the PIANN system 10 may be used to provide a surrogate model 200 for a physics based simulation where the surrogate model 200 is constructed using a PIANN architecture as described herein and may be considered as including or implementing the PIANN 12, at least according to some embodiments. The surrogate model 200 may be configured to provide an output model in the same format as commercial software simulators would and/or to use inputs in the same format and/or of the same kind as those used by commercial software simulations. Of course, depending on the particular application in which the PIANN is being used, the structure, including the input and output structure, may be adapted. This enables current systems to easily transition to using the PIANN-based surrogate model 200 for generating output models.

In one embodiment, the ADAM optimizer with a learning rate of 10⁴ is used for training the PIANN 12. According to one implementation and usage, a total of 80 simulations were generated with experimental design and these were divided with 90 percent for training and 10 percent for testing. Therefore, 8 simulations were used to test the accuracy of the model. In the present example, the hidden state after the encoder DNN is 2048, a reduction of 3,000 times has been carried out after starting with 6M.

The linear transition model (represented as the linear transition layer 20 in FIG. 1) evolves the latent variable from one timestep to the next, given the controls. The inputs to the linear transition model include the latent variable for the current state z^{t} in [symbol] ⁿ^{_{w}}, where l_{z} is the dimension of the latent space, the current step control uₜ in [symbol] ⁿ^{_{w}}, and timestep size dt. The model outputs the predicted latent state for the next timestep, z^{t+1} in [symbol] ^{t}^{_{z}}. It is reiterated that this represents the output of the linear transition model or linear transition layer 20. Different DNNs have been tested before as transition models (Jin et al.) as fully connected layers or as SIRENs, V. Sitzmann, J. Martel, A. Bergman, D. Lindell, G. Wetzstein, Implicit neural representations with periodic activation functions, Advances in Neural Information Processing Systems 33 (2020). These DNN types present a common drawback: error propagation. In other words, given that the output of the DNN is the input for the next timestep, there will be an exponential accumulation of error as the model predicts farther into the future.

In order to reduce this issue, the above-described DNN architecture (and, in particular, the encoder-decoder RNN configuration) which use a memory recurrent neural network (e.g. GRU) to calculate an iterative solver for equations is used. The idea is inspired by euler methods (D. Ravat, Analysis of the euler method and its applicability in environmental magnetic investigations, Journal of Environmental and Engineering Geophysics 1 (1996) 229-238) where a residual term is computed where the term has to be added to previous timesteps to compute future time steps. This residual GRU allows us to compute all future timesteps in one iteration (implicit solver) and is modelled as a seq-to-seq problem, such as those used for natural language processing (NLP), I. Sutskever, O. Vinyals, Q. V. Le, Sequence to sequence learning with neural networks, in: Advances in neural information processing systems, pp. 3104-3112. According to at least one embodiment, the PIANN 12 may use residual RNN units, such as GRUs, as a transition in a deep neural network, such as that shown in FIGS. 2-3 and, in some embodiments, the PIANN 12 is structured as a seq-to-seq RNN.

One of the most relevant aspect to reduce dramatically the data necessary in PINN context is the loss function, at least according to some embodiments. The loss function could be divided into two separate terms: a) “data-based loss” or Loss_{data-based}—this term is the traditional loss function where a minimization is performed for the data obtained from the simulator and the surrogate/PINN model output, ∥uₛᵢₘᵤₗₐₜₒᵣ−u_{PINN}∥_{L2}, where u is pressure and/or saturation; and b) “physics-based loss” or Loss_{physics-based}—this term minimizes the residual computed for every prediction of pressure and saturation; this may be represented by ∥Σₙ₌ᵢ^{Nc}rᵢ∥_{L2} where Nc is the number of cells and the residual is computed following the Equation 2. It is important to note that boundary and initial conditions are introduced in the physics-based loss. Moreover, it should be appreciated that this loss function, which includes a physics-based loss, is considered a physical loss function. The physical loss function may be defined as Loss=Loss_{data-based}+λ*Loss_{physics-based}, where λ is a hyperparameter that may be modified to provide more relevance to data or physical laws or other constraints.

The optimization applied to determine the parameters for the linear transition model is analogous to a key step in POD-TPWL, J. He, L. J. Durlofsky, Constraint reduction procedures for reduced-order subsurface flow models based on pod-tpwl, International Journal for Numerical Methods in Engineering 103 (2015) 1-30. In POD-TPWL, the goal is essentially to minimize the difference between the predicted reduced state ϵ^{t+1} and the projected true state. However, these methods use the Jacobian and Hessian obtained during the reservoir simulation calculation to compute the transition model between different timesteps. For that reason, the acceleration in the reservoir simulation is limited compared to use of deep learning techniques. In order to test the PIANN as constructed according to the present exemplary implementation, the Olympus reservoir (R. Fonseca, E. Della Rossa, A. Emerick, R. Hanea, J. Jansen, Overview of the olympus field development optimization challenge, in: ECMOR XVI-16th European Conference on the Mathematics of Oil Recovery, volume 2018, European Association of Geoscientists & Engineers, pp. 1-10) was used. Olympus is a black-oil two phase public reservoir set up by 50 different geological realizations/simulation, 10 producers wells and 10 water injectors well. The original challenge of OLYMPUS was to compare different optimization algorithm for history match problem. However, Olympus was used to test the above-described exemplary workflow. Forty two (42) simulations were used as training data and eight (8) simulations were used for testing. All experiments were run on a g4dn.4xlarge GPU machine, which is an example of a computing machine.

The results are divided into three different categories: 1) the encoder-decoder; 2) transition deep neural network predicting future timesteps; and 3) full simulation from encoder-transition-decoder.

In order to check the accuracy of the model, the results from Eclipse and our model were compared and the relative error maps and absolute error maps were computed (Table 1). Results show that we can get an average maximum error for the testing set smaller than 4.5 percentage for pressure and 8 percentage in Saturation.

TABLE 1
relative and absolute error for pressure and saturation maps for PINN

| | Average Error for 8 different realizations | |
|---|---|---|
| Unknown variable | Absolute Error | Relative Error |
| Pressure | 100 PSI | 4.3% |
| Saturation | 0.02 | 7.7% |

In addition, the correlation between different timesteps in the new hidden spaces was compared and the results show there is a linear correlation between different timesteps which reduce the complexity for the task of the physical DNN solver (corresponding to the linear transition layer 20). It is important to note that this certifies one of the main tasks of the DNN physical solver, the linearity between different timesteps of the unknown variables in the hidden spaces.

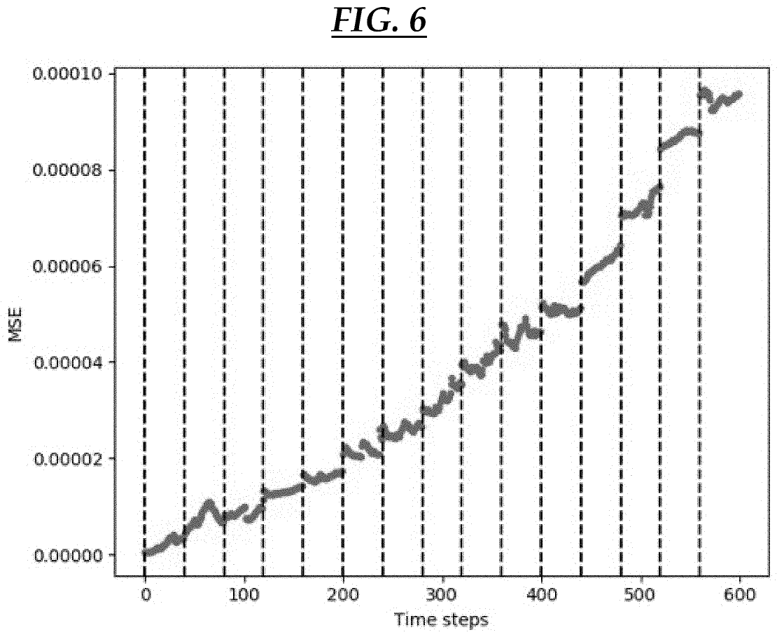

One of the main limitations to applying deep neural networks to predict time series problems is the error propagation. Several papers in the literature have proposed simple deep neural networks to predict future steps of the hidden spaces. However, the error increases exponentially after a few timesteps. As explained above, a memory recurrent neural network with a model order reduction formulation was used, which is characterized above by the encoder-decoder RNN configuration of the PIANN 12. FIG. 6 shows the error propagation for different timesteps. It can be observed that the trends are completely linear and the loss function of the deep neural network is kept small. This is an important advantage of the PIANN system over conventional systems for solving PDE(s) generally and, in particular, for reservoir modeling as exemplified herein.

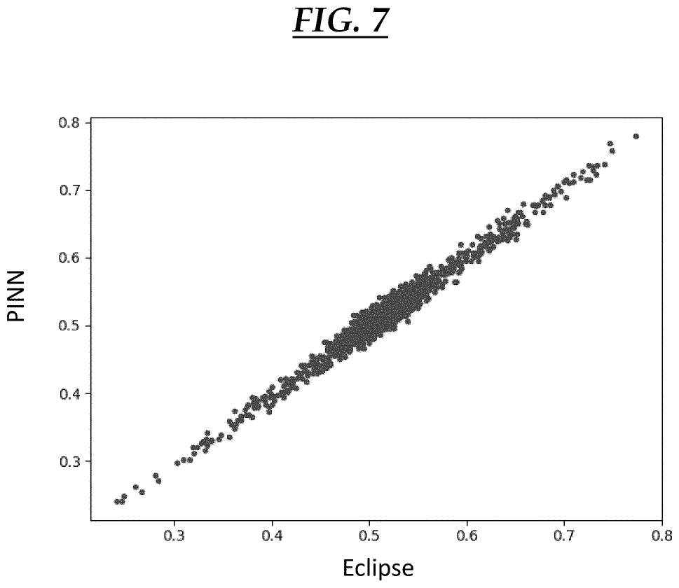

In addition, results show very small differences between Eclipse and the disclosed PINN in the hidden spaces, and these differences are smaller after reconstructions back to original spaces, getting a maximum relative error in the testing sets of less than 1 percentage. In addition, the correlation between Eclipse and the disclosed PINN in the hidden spaces was compared, and it can be observed that a linear correlation between them with very small bias exists as shown in FIG. 7. This demonstrates the correlation between the different timesteps and the accuracy of the DNN. In order to analyze the error in more detail, the reconstruction and propagation error were analyzed separately, Table 2. Although the total error is small in a global sense, the reconstruction error is contributing around 90 percentage of the total error. This shows that more focus should be given to improving compression in the neural spaces. Finally to compare the speed-up of our new technique, the training and simulation time of the disclosed methodology were compared with the commercial simulator. The disclosed model could be trained in less of one hour and the forward model run in less one second instead of twenty minutes of the traditional simulator which is four order of magnitudes difference. It may be important to note that several neural network architecture could be used for encoder-decoder the neural network with the objective to reduce and project the solution. For at least that reason, this part of the workflow is not limited to the architecture described in this exemplary implementation. As discussed above, deep learning methods hold the key to revolutionizing many scientific disciplines by providing fast solvers that approximate traditional ones. However, classical neural networks map between finite-dimensional spaces and can therefore only learn solutions tied to specific discretization(s). This is often an insurmountable limitation for practical applications and therefore the development of mesh-invariant, where our network does not depend on the grid, neural networks is required.

TABLE 2
Comparison of the error for Encoder-Decoder (Neural network) and LSTM implicit solver
for Pressure variable

| | Average Error for 8 different realizations | |
|---|---|---|
| PINN | Mean Square Error (L2) | Relative error |
| Encoder-Decoder (Neural Physics DNN) | 10⁻⁴ | 7% |
| LSTM Implicit Solver | 3 * 10⁻⁶ | 0.7% |
| Total Error | — | 7.7% |

Exemplary Implementation of PIANN for Buckley-Leverett (BL) Model

The discussion below refers to an exemplary implementation of the PIANN 12 for purposes of Buckley-Leverett (BL) modelling. It should be appreciated that this discussion presents an exemplary implementation of the PIANN 12 and that the technical features and details discussed below may be applied to the PIANN 12, but do not necessarily limit the PIANN 12. Moreover, the discussion below relates to generating a PIANN (such as the PIANN 12) for BL modeling using a PIANN system having certain specified components, such as certain encoders, optimizers, etc. It should further be appreciated that, according to other implementations and/or embodiments, the PIANN and/or PIANN system may be adapted to use other components.

A challenged addressed by the PIANN system 10, at least according to some embodiments, is to extend the PINN for more complicated differential equations, such as parabolic equations (J. D. Cole, On a quasi-linear parabolic equation occurring in aerodynamics, Quarterly of applied mathematics 9 (1951) 225-236) where only initial condition(s), boundary condition(s), and residual(s) are used to train the model.

Learning solutions of nonlinear PDEs using current network architectures presents some of the same limitations of classical numerical discretization schemes. For instance, one of the main limitations of classical numerical methods (e.g. finite differences, volumes, elements) is the need to devise suitable upwind discretizations that yield smooth and accurate solutions near the shock fronts. Methods that use centered approximations, without numerical dissipation, such as standard finite differences or the Galerkin finite element method, lead to solutions that are polluted by spurious oscillations around the shock front, often leading to numerical instabilities. PINN might present similar issues if the same schemes are used to calculate residuals.

A paradigmatic example is the solution of hyperbolic PDEs. Hyperbolic conservation laws describe a plethora of physical systems in gas dynamics, acoustics, elastodynamics, optics, geophysics, and biomechanics. Hyperbolic PDEs are challenging to solve numerically using classical discretization schemes, because they tend to form self-sharpening, highly-localized, nonlinear shock waves that require specific approximation strategies and fine meshes. Solving hyperbolic PDEs seems to be challenging for neural networks as well, as the ability of current PINNs to learn PDEs with a dominant hyperbolic character relies on adding artificial dissipation, or on using a priori knowledge to increase the number of training points along the shock trajectories or adaptive activation functions.

One example of this parabolic equation is Buckley-Leverett (BL) model, where the objective is to estimate the rate at which an injected water bank moves through a porous medium, R. E. Guzman, F. J. Fayers, Solutions to the three-phase buckley-leverett problem, in: ECMOR V-5th European Conference on the Mathematics of Oil Recovery, European Association of Geoscientists & Engineers, pp. cp-101. Several authors have failed in solving this model in a heterogeneous environment (Tchelepi et al.) due to the neural network completely missing the correct location of the saturation front independently of the deep neural network architecture. The disclosed PIANN 12 may be adapted to address such a problem, as described below according to the present exemplary implementation.

In this exemplary implementation, a new perspective is proposed on solving hyperbolic PDEs and traditional limitations of classical numerical methods using deep learning. The proposed method relies in two core ideas: (1) a modified PINN architecture can provide a more general method for solving hyperbolic conservation law problems without a priori knowledge or residual regularization; and (2) relating network architecture with the physics encapsulated in a given PDE is possible and has a beneficial impact. The PIANN 12 may be adapted for sophisticated, physics-specific network architectures (i.e., networks whose internal hierarchy is related to the physical processes being learned) may be more effectively trained and easier understood than standard feed-forward multilayer perceptrons.

According to the present exemplary implementation, the PIANN 12 uses the transition zone detector 14 to automatically detect shocks in the solution of hyperbolic PDEs. The use of transition zone detector 14 to enrich PINN network architectures results in a network that is a combination of RNN units (e.g., GRUs) and attention mechanism(s), as described above. The combination of both elements in the architecture allows for determination of the most relevant information (recurrent neural network with memory) to adapt the behavior of the deep neural network to approximate sharp shocks without the necessity of residual regularization or a priori knowledge (attention mechanism).

Previous works as Raissi et al., Fraces et al., and Sun et al. introduced initial and boundary conditions in the formulation as a penalty term in the objective function. The main drawback of this approach is, if this term was not exactly zero after training, the boundary condition is not completely satisfied. Others, such as Lagaris et al. make use of the Extreme Theory of Functional Connections (Mortari, D. The theory of connections: Connecting points. Mathematics 5, 10 (2017)) to enforce the initial and boundary conditions in the solution. As in these works, in the present architecture, the initial and boundary conditions are also enforced as hard constraints, at least according to the exemplary implementation.

The PIANN approach is tested by solving a classical hyperbolic model problem, namely the Buckley-Leverett equation. The Buckley-Leverett equation with non-convex flux function is an excellent benchmark to test the overall potential of PIANNs in solving hyperbolic PDEs. It is found that PIANNs effectively capture the shock front propagation and are capable of providing high quality solutions for mobility ratios inside the convex hull of training set. Remarkably, PIANNs are able to provide smooth, accurate shock fronts without explicitly introducing additional constraints or dissipation in the residual, through an artificial diffusion term or upwinding the spatial derivatives.

Problem Formulation for Exemplary Implementation of PIANN for BL Model

The problem of interest is that of two immiscible fluids flowing through a horizontal porous medium. It is further assumed that the fluids and overall system are incompressible. The Buckley-Leverett (BL) equation describes the evolution in time and space of the wetting-phase (water) saturation. Let u_{M}: [symbol] ₀⁺× [symbol] ₀⁺→[0, 1] be the solution of the BL equation:

$$\frac{\partial {u}_{M}}{\partial t} ( x , t ) + \frac{\partial {f}_{M}}{\partial x} ( x , t ) = 0 \qquad ( BL - EQ 1 )$$

$${u}_{M} ( x , 0 ) = 0 , ∀ x > 0 Initial condition \qquad ( BL - EQ 2 )$$

$${u}_{M} ( 0 , t ) = 1 , ∀ t \geq 0 Boundary condition \qquad ( BL - EQ 3 )$$

where u_{M} represents the wetting-phase saturation, f_{M} is the fractional flow function and M is the mobility ratio of the two fluid phases. The subscript M is used to indicate that, once the form of the constitutive relations is specified, the solutions of problem (BL-EQ 1)-(BL-EQ 3) are characterized solely by the mobility ratio.

This first-order hyperbolic equation is of interest as its solution can display both smooth solutions (rarefactions) and sharp fronts (shocks). Although the solution to this problem can be obtained analytically for simple one-dimensional settings, the precise and stable resolution of these shocks poses well-known challenges for numerical methods, Leveque, R. J. Numerical Methods for Conservation Laws (2. ed.). Lectures in Mathematics: ETH Zurich (Birkauser, 1992.

PINNs have been tested on this problem by Fuks and Tchelepi (Tchelepi et al.) who report good performance for concave fractional flow functions. In addition, Fraces and Tchelepi (C. F. & Tchelepi, H. Physics informed deep learning for flow and transport in porous media (2021)) provide an accurate solution introducing two physical constrains and subsequently modifying the fractional flux equation by a piece-wise form which differentiable form allow to capture the shock. However, these constraints are problem dependent and do not provide a general solution for hyperbolic equations in heterogeneous media. Whether the solution of the BL problem with non-convex flux function can be learnt by deep neural networks without the aid of artificial physical constraints remains an open question.

f_{M} is taken to be the S-shaped flux function

$${f}_{M} ( x , t ) = \frac{{{u}_{M} ( x , t )}^{2}}{{{u}_{M} ( x , t )}^{2} + \frac{1}{M} {( 1 - {u}_{M} ( x , t ) )}^{2}} \qquad ( BL - EQ4 )$$

for which the analytical solution of the problem can be obtained:

$${u}_{M} ( x , t ) = \{ \begin{matrix}0 , & \frac{x}{t} > {f}_{M}^{′} ( {u}^{*} ) , \\ {( {f}_{M}^{′} )}^{- 1} ( \frac{x}{t} ) , & {f}_{M}^{′} ( {u}^{*} ) \geq \frac{x}{t} \geq {f}_{M}^{′} ( u = 1 ) \\ 1 , & {f}_{M}^{′} ( u = 1 ) \geq \frac{x}{t}\end{matrix} \qquad ( BL - EQ5 )$$

where f′_{M}(u*) [f_{M}(u*)−f_{M}(u)|ᵤ₌₀]/(u*−u|ᵤ₌₀), and u* represents the shock location defined by the Rankine-Hugoniot condition. Note that equation (BL-EQ5) describes a family of functions of space, time, characterized by fluid mobility ratio M, u_{M}(x, t). This analytical solution is used to test the accuracy of the PIANN model.

Methodology for Exemplary Implementation of PIANN for BL Model

Let [symbol] :={(xᵢ, tⱼ) ∈ [symbol] ₀⁺× [symbol] ₀⁺: i=0, . . . , N, j=0, . . . , T} be a discrete version of the domain of u_{M}. The PIANN may be defined as a vector function u_{θ}: [symbol] ₀⁺× [symbol] ⁺→[0,1]^{N+1} where θ are the weights of the network to be estimated during training. The inputs for the proposed architecture are pairs of (t, M) and the output is a vector where the i-th component is the solution evaluated in xᵢ. The different treatment applied to spatial and temporal coordinates is of particular note. Whereas t is a variable of the vector function u_{θ}, the locations where we calculated the solution x₀, . . . , x_{N} are fixed in advance. The output is a saturation map and therefore its values have to be in the interval [0, 1].

The architecture of u₀ was introduced above (under Exemplary PIANN architecture), and it is noted here that in order to enforce the boundary condition, the PIANN is allowed to learn only the components u_{θ}(t, M)₁, . . . , u_{θ}(t, M)_{N}, ∀t≠0 and then we concatenate the component u_{θ}(t, M)₀=1. At least according to some implementations, Non-Dirichlet boundary conditions would require to be included as a term of the loss function. To enforce the initial conditions, we set u_{θ}(t, M)ᵢ=0, i=1, . . . , N. To enforce that the solution be in the interval [0, 1], a sigmoid activation function is applied to each component of the last layer of the PIANN 12.

The parameters of the PIANN are estimated according to the physics-informed learning approach, which states that 0 can be estimated from the BL-EQ1, the initial conditions BL-EQ2 and boundary conditions BL-EQ3, or in other words, no examples of the solution are needed to train a PINN.

After utilizing the information provided by the initial and boundary conditions enforcing u_{θ}(0, M)ᵢ=0, i=1, . . . , N and u_{θ}(t, M)₀=1, respectively, a loss function is defined based on the information provided by BL-EQ1. To calculate the first term, two options may be used. The first option is a central finite difference approximation, that is

$${{ℛ}_{1} ( θ , M )}_{i , j} = \frac{{{u}_{θ} ( {t}_{j + 1} , M )}_{i} - {{u}_{θ} ( {t}_{j - 1} , M )}_{i}}{{t}_{j + 1} - {t}_{j - 1}} , \begin{matrix}i = 1 , … , N - 1 \\ j = 1 , … , T - 1\end{matrix} \qquad ( BL - EQ6 )$$

Alternatively, the derivative of the PIANN may be calculated with respect to t since the functional form of u_{θ} is known. It can be calculated using the automatic differentiation (AD) tools included in many machine learning libraries, such as Pytorch. Thus, a second option that is proposed is to calculate this term as

$${{ℛ}_{2} ( θ , M )}_{i , j} = \frac{{{f}_{θ} ( {t}_{j} , M )}_{i + 1} - {{f}_{θ} ( {t}_{j} , M )}_{i - 1}}{{x}_{i + 1} - {x}_{i - 1}} , \begin{matrix}i = 1 , … , N - 1 \\ j = 1 , … , T - 1\end{matrix} \qquad ( BL - EQ7 )$$

where the vector of fluxes at the i-th location xᵢ is calculated as

$${{f}_{θ} ( t , M )}_{i} = \frac{{{u}_{θ} ( t , M )}_{i}^{2}}{{{u}_{θ} ( t , M )}_{i}^{2} + \frac{{( 1 - {{u}_{θ} ( t , M )}_{i} )}^{2}}{M}} , i = 0 , … , N \qquad ( BL - EQ8 )$$

The spatial coordinate x is included as a fixed parameter in our architecture.

The loss function to estimate the parameters of the PINN is given as

$$ℒ ( θ ) = {\sum }_{M} {‖ {1}_{} ( θ , M ) + {2}_{} ( θ , M ) ‖}_{F}^{2} \qquad ( BL - EQ 9 )$$

where ∥⋅∥_{F} is the Frobenius norm.

There are two main lines in PINNs literature to deal with the initial and boundary conditions. The first one is to include them as a penalty term in the objective function (Raissi et al.; Fraces et al.; Sun et al.). The main drawback of this approach is, if this penalty term is not zero after training, the initial and boundary conditions are not totally satisfied by the solution. To solve this problem, we directly enforce the initial and boundary conditions in the architecture of our PIANN. Thus, we follow the path of the second line in PINN literature (Lagaris, I., Likas, A. & Fotiadis, D. Artificial neural networks for solving ordinary and partial differential equations. IEEE Neural Netw. 9, 987-1000 (1998)) that enforces initial and boundary conditions as hard constraints. With respect to the first line, this provides several advantages. First, we enforce a stronger constraint that does not allow any error on the initial and boundary conditions. Second, the PIANN does not need to learn these conditions by itself, according to at least some embodiments, and it can instead concentrate exclusively on learning the parameters that minimize the residuals of the BL equation. Third, there are no weights to be tuned to control the effect of the initial and boundary conditions in the final solution, at least according to some embodiments.

The parameters of the PIANN are estimated using the Adam optimizer (Kingma, D. P. & Ba, J. Adam: A method for stochastic optimization. arXiv preprint arXiv: 1412. 6980 (2014)) to minimize (BL-EQ9) with respect to θ. Training algorithm pseudo-code is provided in Algorithm 1.

Algorithm 1 Training algorithm pseudo-code for PIANN

Require: [symbol] a set of time values t, [symbol] a set of values for M, and initial values for neural net parameters θ

| | |
|---|---|
| 1: | repeat |
| 2: | Forward pass of PIANN to calculate all u_{θ}(t, M),∀(t,M) ∈ [symbol] × [symbol] |
| 3: | Calculate the first term of the residual [symbol] ₁(θ, M) as in eq. (6). |
| 4: | Calculate the values of the flux function f_{θ}(t,M) using eq, (8). |
| 5: | Calculate the second term of the residual [symbol] ₂(θ,M) using the values of flux function in eq. (7). |
| 6: | Calculate the objective function [symbol] (θ) as in eq. (9). |
| 7: | Calculate the derivatives of [symbol] (θ) with respect to θ using automatic differentiation. |
| 8: | Update the parameters θ of the PIANN according to Adam optimizer steps. |
| 9: | until convergence |
| 10: | output The optimized parameters of the PIANN θ |

Note:
the equation references “eq. (#)” refer to the BL-EQ above as BL-EQ#.

In the present exemplary implementation, random initialization was used for neural net parameters θ.

It should be appreciated that while the exemplary implementations provide examples of certain particular implementations of such a PIANN system 10, the PIANN system 10 may be used for a variety of other purposes, such as for solving other hyperbolic PDEs or producing other models having physical constraints and/or limited available data for training.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A physics-informed attention-based neural network (PIANN) system, wherein the PIANN system is a computer system configured to implement a PIANN, the computer system comprising at least one processor and memory storing computer instructions,
wherein, when the at least one processor executes the computer instructions, the PIANN system is trained to learn a solution or model for a partial differential equation (PDE) respecting one or more physical constraints,
wherein the PIANN includes a physics-informed neural network (PINN) implementing a deep neural network and a transition zone detector, and
wherein the PIANN implements a recurrent neural network (RNN).

2. The PIANN system of claim 1, wherein the PIANN includes an encoder and a decoder.

3. The PIANN system of claim 2, wherein the encoder is used to map an encoder input to an encoder output in an embedding space, and wherein the decoder is used to map a decoder input in the embedding space to a decoder output.

4. The PIANN system of claim 3, wherein the encoder input size and decoder input size are equal.

5. The PIANN system of claim 3, wherein a linear transition layer is introduced in the embedding space between the encoder and the decoder.

6. The PIANN system of claim 1, wherein the PIANN includes a plurality of RNN units.

7. The PIANN system of claim 6, wherein the plurality of RNN units include at least one gated recurrent unit (GRU) and/or at least one long short-term memory (LSTM).

8. The PIANN system of claim 7, wherein the one or more RNN units include a plurality of GRUs.

9. The PIANN system of claim 7, wherein the one or more RNN units include a first plurality of GRUs and a second plurality of GRUs, and wherein the first plurality of GRUs are used as a part of an encoder of the PIANN and the second plurality of GRUs are used as a part of a decoder of the PIANN.

10. The PIANN system of claim 9, wherein the transition zone detector includes an attention mechanism implemented as an attention layer introduced between the first plurality of GRUs and the second plurality of GRUs.

11. The PIANN system of claim 10, wherein the attention layer is used to calculate a context vector based on encoder hidden states corresponding to the first plurality of GRUs.

12. The PIANN system of claim 11, wherein the context vector is calculated based on attention weights that are determined based on the encoder hidden states corresponding to the first plurality of GRUs.

13. The PIANN system of claim 12, wherein the context vector is used as input into at least one of the second plurality of GRUs.

14. The PIANN system of claim 1, wherein the PDE is a non-linear PDE.

15. The PIANN system of claim 1, wherein the PDE is a hyperbolic PDE.

16. The PIANN system of claim 1, wherein the PIANN includes an automatic differentiator for producing a differentiation output, and wherein the differentiation output is used for training the PIANN in order to update one or more parameters or weights of the PIANN.

17. The PIANN system of claim 16, wherein the one or more parameters or weights of the PIANN include one or more transition zone detector weights or parameters weights of the transition zone detector.

18. The PIANN system of claim 17, wherein the transition zone detector is an attention mechanism and the transition zone detector weights or parameters are attention weights of the attention mechanism.

19. The PIANN system of claim 1, wherein the PIANN is structured as a seq-to-seq RNN.

20. A physics-informed attention-based neural network (PIANN) system, wherein the PIANN system is a computer system configured to implement a PIANN, the computer system comprising at least one processor and memory storing computer instructions,
wherein, when the at least one processor executes the computer instructions, the PIANN is used to generate a surrogate model for use in generating a simulation output, and
wherein the PIANN includes a physics-informed neural network (PINN) with an attention mechanism introduced into an embedding space of the PINN between an encoder and a decoder of the PINN.

20. The PIANN system of claim 19, wherein the attention mechanism is a hard attention mechanism.

21. The PIANN system of claim 19, wherein the attention mechanism is a soft attention mechanism.

22. The PIANN system of claim 19, wherein the PIANN includes an encoder-decoder recurrent neural network (RNN) configuration having a plurality of RNN units, and wherein the plurality of RNN units are used to generate an encoder output in the embedding space and/or to generate a decoder input in the embedding space.

23. The PIANN system of claim 18, wherein the PIANN includes automatic differentiator for producing a differentiation output, and wherein the differentiation output is used by a physics-informed learning unit for physics-informed learning or training of the PINN.

24. The PIANN system of claim 23, wherein the PIANN includes a physics-informed learning unit that is uses a physical loss function.

25. The PIANN system of claim 24, wherein the physical loss function is formulated based on a Buckley-Leverett (BL) equation.

26. The PIANN system of claim 18, wherein the surrogate model is a reservoir model.

27. The PIANN system of claim 24, wherein the physics-informed learning unit enforces one or more initial conditions and one or more boundary conditions representing or selected in accordance with one or more physical constraints.

28. A deep neural network (DNN) system, wherein the DNN system is a computer system configured to implement a DNN having an encoder and a decoder coupled together in an embedding space through an attention layer implementing an attention mechanism, the computer system comprising at least one processor and memory storing computer instructions,
wherein, when the at least one processor executes the computer instructions, the DNN architecture is used to generate a DNN output that respects one or more predetermined physical constraints.

29. The DNN system of claim 28, wherein the attention layer is coupled to a plurality of recurrent neural network (RNN) units of the encoder and coupled to a plurality of RNN units of the decoder.

30. The DNN system of claim 29, wherein one or more weights or parameters of the encoder, the decoder, and/or the attention layer are trained using a physics-informed learning unit that is uses a physical loss function and that respects the one or more predetermined physical constraints.
